(19) United States
(12) Patent Application Publication
(10) Pub. No.: US 2012/0097460 A1
(43) Pub. Date: Apr. 26, 2012

(54) HYDRAULICALLY-POWERED WORKING VEHICLE

(75) Inventors: Kazuhiro OWADA, Amagasaki (JP); Hideki KANENOBU, Amagasaki (JP); Koji SAKATA, Amagasaki (JP); Takeshi OKAZAKI, Amagasaki (JP)

(73) Assignees: YANMAR CO., LTD., Osaka (JP); KANZAKI KOKYUKOKI MFG. CO., LTD., Amagasaki (JP)

(21) Appl. No.: 13/279,524

(22) Filed: Oct. 24, 2011

(30) Foreign Application Priority Data
Oct. 25, 2010 (JP) 2010-238426

(51) Int. Cl. B62D 11/06

(52) U.S. Cl. 180/6.58

(57) ABSTRACT

A hydraulically powered working vehicle includes a turning section provided at an upper side of a travel unit capable of turning, and hydraulic circuits for the working vehicle. The hydraulic circuit for the working vehicle has a first actuator group including a one side traveling motor, a first variable capacity pump for driving the first actuator group, a second actuator group including an other side traveling motor and a turning motor, and a second variable capacity pump for driving the second actuator group. The second variable capacity pump is set so that a maximum value for discharge capacity per unit time becomes large compared to that of the first variable capacity pump.

### PRIORITY INFORMATION

This application claims priority to Japanese patent application No. 2010-238426, filed on Oct. 25, 2010, which is incorporated herein by reference in its entirety.

### BACKGROUND OF THE INVENTION

1. Field of the Invention

The present invention relates to a hydraulically-powered working vehicle used as an excavation vehicle such as excavator that uses a bucket etc, comprising a travel unit made up of a one side travel section and another side travel section that are capable of being driven independently of each other, a turning section provided above the travel unit and being capable of turning, and an operation section such as an excavation section supported on the turning section.

2. Description of the Related Art

With a excavator, which is a ground working vehicle, for example, of the related art, an arm, boom, and excavation section including a bucket and fork etc, are provided on an upper structure, which is a turning section, and an excavation operation is possible by operating the excavation section using hydraulic actuators such as hydraulic cylinders. For example, an excavator, which is a hydraulically-powered working vehicle, is disclosed in JP 2007-100317A.

The excavator disclosed in JP 2007-100317A is comprised of a travel section including a travel unit, a bearing supported above the travel section, a rotation platform arranged on the bearing, and an excavation section including a boom and arm etc. The boom cylinder is arranged between the boom and a boom bracket, and a swing cylinder is arranged between the boom bracket and the rotation platform. Left and right traveling motors are arranged in the travel unit. A turning motor is also arranged inside the rotation platform, and is constructed to be able to rotate the rotation platform. First to third hydraulic pumps are driven by an engine, and of these three pumps, pressure discharged from variable capacity first and second hydraulic pumps is connected by way of a switching valve to a boom cylinder, swing cylinder and traveling motor etc., making drive possible. Hydraulic oil from a fixed capacity third hydraulic pump is connected by way of a switching valve to a turning motor, enabling turning drive.

In the case of the hydraulically-powered working vehicle disclosed in JP 2007-100317A, a third hydraulic pump that is separate from hydraulic pumps for other actuators is used for the turning motor. The number of pumps is therefore increased, which is likely to hinder plans for cost reduction and reduction in power loss.

On the other hand, with a power shovel disclosed in JP 4-9922B, supply of discharge fluid to a traveling motor, swing cylinder and boom cylinder is made possible using a shared variable capacity pump P1, and supply of discharge fluid to a turning motor, separate traveling motor and arm cylinder is made possible using a shared variable capacity pump P2. However, with this type of structure, in the case where rotation operations of a turning section and an arm that is a separate actuator from a turning section are carried out simultaneously, discharge capacity from the variable capacity pump P2 is insufficient, operation speed of the respective actuators is lowered, and there is a possibility of smoothness of the operation being impaired. This is therefore a cause of lowering of the working efficiency of the excavation operation. Specifically, with a working vehicle provided with a turning section, there are cases where it is possible to increase working efficiency by turning the turning section while moving an operation section, such as an excavation section, up and down or to the left and right rotationally. On the other hand, with the technology disclosed in JP 4-9922B, turning of the turning section and rotation of an arm can not be carried out efficiently at the same time, and as well as being a hindrance to planned cost reduction and reduction in power loss there is scope for improvement from the point of view of being able to carry out operation using the turning section smoothly and in a short time.

In JP 2000-220566A there is disclosed transmitting rotational force by the meshing of a drive gear that is fixed to a drive pump with a driven gear that is fixed to a driven pump, using a hydraulic pump having a drive pump and a driven pump. Also, this type of hydraulic pump is used for the drive of each actuator of a hydraulic shovel. However, in JP 2000-220566A, a structure for carrying out operation using a turning section smoothly and in a short time is not disclosed.

Also, in JP 6-10827A there is disclosed a hydraulic pump where a pair of cylinder blocks are provided on a pair of rotation shafts, a pair of gears having different numbers of teeth are fixed to the pair of rotation shafts, and the associated pairs of gears mesh with each other. This type of hydraulic pump can arbitrarily increase or reduce maximum flow rate of the pump by varying a ratio of numbers of teeth of the gears. However, this type of hydraulic pump is of oblique type or swash plate type, but capacities of two internal pumps are fixed. Also, this type of hydraulic pump is only connected to an actuator such as a hydraulic cylinder. In the case of JP 6-10827A also, a structure for carrying out operation using a turning section smoothly and in a short time is not disclosed.

Thus, in the case of the art disclosed in JP 2007-100317A, JP 4-9922B, JP 2000-220566A and JP 6-10827A, in a hydraulically-powered working vehicle there is scope for improvement from the point of view of reduction in cost and power loss, and carrying out an operation using a turning section smoothly and in a short time.

### SUMMARY

An object of the present invention is to realize a structure, in a hydraulically-powered working vehicle, to bring about cost reduction and reduction in power loss, and also to make it possible to carry out operation using a turning section smoothly and in a short time.

A hydraulically-powered working vehicle of the present invention comprises a travel unit including a one side travel unit and an other side travel unit that are capable of being driven independently of each other, a turning section provided capable of turning at an upper side of the travel unit, an operation section supported on the turning section, and a hydraulic circuit for the working vehicle, including a plurality of types of actuator, having a one side traveling motor, which is an actuator for driving the one side travel section, an other side traveling motor, which is an actuator for driving the other side travel section, and a turning motor which is an actuator for turning the turning section, wherein the plurality of types of actuator are divided into two groups, being a first actuator group including the one side traveling motor, and a second actuator group including the turning motor and the other side travel monitor, the hydraulic circuit for the working vehicle includes a first circuit having the first actuator group and a first variable capacity pump for driving the first actuator group, and a second circuit having the second actuator group and a second variable pump for driving the second actuator group, and the second variable capacity pump constituting the drive source for the turning motor is set so that a maximum value for discharge capacity per unit time becomes large compared to that of the first variable capacity pump.

### BRIEF DESCRIPTION OF THE DRAWINGS

FIG. 1 is a schematic diagram of a excavator, being a hydraulically-powered working vehicle of a first embodiment of the present invention.

FIG. 2 is a plan view showing a plurality of units provided inside an equipment storage section constituting the excavator of FIG. 1, with some parts omitted.

FIG. 3 is an overall diagram of hydraulic circuits of the excavator of FIG. 1.

FIG. 4 is a hydraulic circuit diagram for a pump unit constituting the excavator of FIG. 1.

FIG. 5 is a transverse cross-sectional drawing of the pump unit constituting the excavator of FIG. 1.

FIG. 6 is a cross sectional drawing taken along A-A of FIG. 5.

FIG. 7 is a drawing looking from the left side to the right side of FIG. 6, with a port block taken out of FIG. 6.

FIG. 8 is a cross sectional drawing taken along B-B of FIG. 6.

FIG. 9 is a cross sectional drawing along C-C of FIG. 6, with some parts omitted.

FIG. 10 is a drawing looking from the left side to the right side of FIG. 6.

FIG. 11 is a drawing looking from the upper side to the lower side of FIG. 6.

FIG. 12 is a cross sectional drawing taken along D-D of FIG. 6.

FIG. 13 is a cross sectional drawing taken along E-E of FIG. 6.

FIG. 14 is a drawing showing an attachment state of a lever for rotational angle detection, showing a state where a rotational angle sensor and sensor support members have been omitted from FIG. 11.

FIG. 15 is a drawing for describing operation of a balanced piston mechanism that drives a servo mechanism, in the pump unit of FIG. 5.

FIG. 16 is a hydraulic circuit diagram for a pump unit of a second embodiment of the present invention.

### DESCRIPTION OF EXEMPLARY EMBODIMENTS

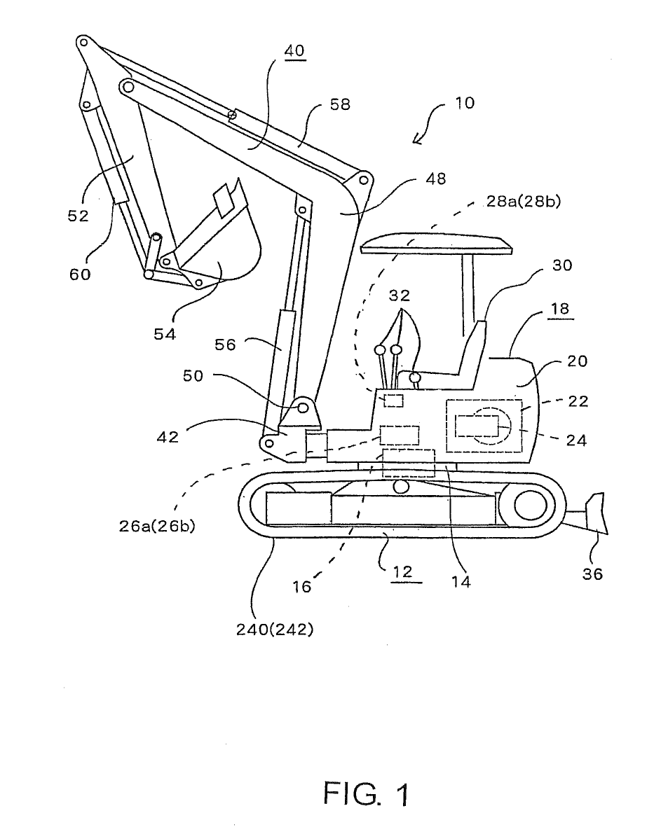

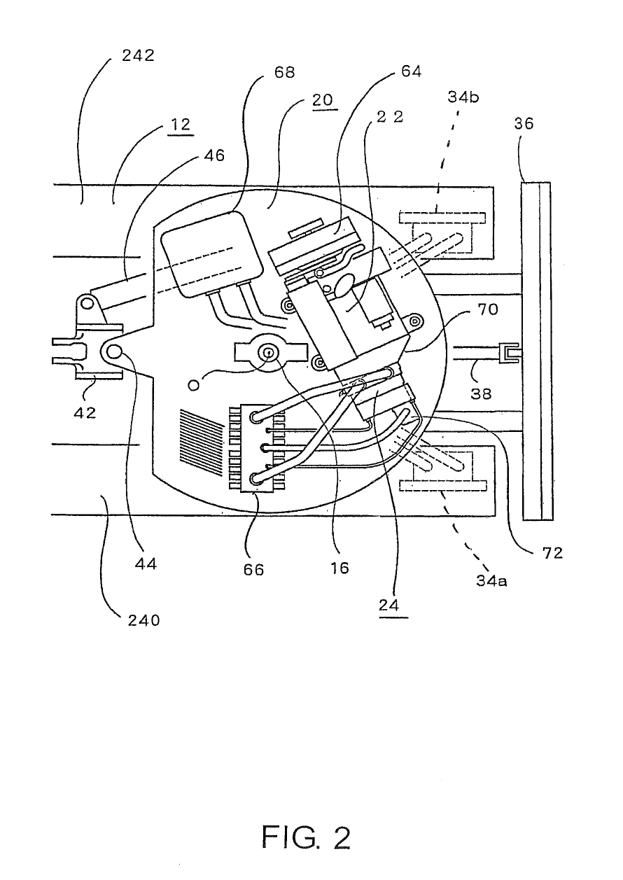

Embodiments of the present invention will be described in detail below using the drawings. FIG. 1 to FIG. 15 are drawings showing a first embodiment of the present invention. As shown in FIG. 1, a excavator 10, being a hydraulically-powered working vehicle of this embodiment, comprises a travel unit 12 including a pair of left and right crawler belts 240, 242, a rotation platform 14 arranged at a middle part of the travel unit 12, a turning motor 16 provided at a middle part of the rotation platform 14, an upper structure 18 that is a turning section provided at an upper side of the travel unit 12 capable of being turned about a vertical turning axis O (FIG. 2) by the rotation platform 14, and an excavation section 40, being a working section supported on the upper structure 18.

Also, the pair of left and right crawler belts 240, 242 are a left side crawler belt 240, being a one side travel section, and a right side crawler belt 242, being an other side travel section, capable of being respectively independently driven. The hydraulically powered working vehicle of the present invention is not limited to a excavator, and can be realized by various vehicles provided with a travel unit, a turning section capable of turning, and a working section supported on the turning section, and having a turning motor and a traveling motor.

As shown in FIG. 1, the upper structure 18 includes an equipment housing section 20 provided at an upper side and having an opening section blocked off by a cover section. An engine 22, being a drive source, pump unit 24, a plurality of directional control valves 26a, 26b, and a plurality of switching pilot valves 28a, 28b are provided inside the equipment housing section 20. A driver's seat 30 is also provided at an upper outer side of the equipment housing section 20. Operation elements 32 such as operation levers and pedals linking to the switching pilot valves are provided to the front, and to the left or right, or on both sides of the driver's seat 30.

The upper structure 18 is capable of being rotated about a vertical turning axis O (FIG. 2) with respect to the travel unit 12, by the turning motor 16. Specifically, the turning motor 16 is an actuator for turning the upper structure. Also, left and right crawler belts 240, 242 provided on the travel unit 12 are capable of being rotated to the advancing side or reversing side of the vehicle by respectively corresponding two traveling motors 34a and 34b (FIG. 2). Specifically, the left side crawler belt 240 is an actuator, and is driven by the left side traveling motor 34a which is the one side traveling motor. On the other hand the right side crawler belt 242 is an actuator, and is driven by the right side traveling motor 34b which is the other side traveling motor. The left and right traveling motors 34a, 34b are driven independently of each other. A blade 36, being an earthmoving machine, is attached to the rear side (right side in FIG. 1) of the travel unit 12, and the blade 36 is supported on the travel unit 12 capable of being moved up and down by expansion and contraction of a blade cylinder 38 (FIG. 2).

An excavation section 40 is attached to a front part (left part in FIG. 1) of the upper structure 18. A lower end section of the excavation section 40 is supported on a swing support section 42. As shown in FIG. 2, the swing support section 42 is capable of rotating about the vertical (perpendicular to the drawing sheet of FIG. 2) axis 44 at the front part of the upper structure 18. A swing cylinder 46 is provided between the swing support section 42 and the upper structure 18. As shown in FIG. 1, a boom 48 of the excavation section 40 is supported at the swing support section 42 capable of swinging about a horizontal axis 50.

The excavation section 40 includes a boom 48, an arm 52 supported on a tip end of the boom 48 capable of rotating up and down, and a bucket 54 supported on a tip end of the arm 52 capable rotating up and down. A boom cylinder 56 is attached between a intermediate part of the boom 48 and the swing support section 42, and the boom 48 is capable of rotating up and down as a result of expansion and contraction of the boom cylinder 56.

An arm cylinder 58 is attached between a intermediate part of the boom 48 and an end part of the arm 52, and the arm 52 is capable of rotation with respect to the boom 48 as a result of expansion and contraction of the arm cylinder 58. Also, a bucket cylinder 60 is attached between an end part of the arm 52 and a link that is coupled to the bucket 54, with the bucket 54 being capable of rotation with respect to the arm 52 as a result of expansion and contraction of the bucket cylinder 60. As shown in FIG. 2, the whole of the excavation section 40 (FIG. 1) is capable of swinging to the left and right with expansion and contraction of a swing cylinder 46.

An engine 22, a radiator 64 for engine cooling, a pump unit 24 connected to the engine 22, a valve unit 66 including a plurality (in the case of this example, 8) of directional control valves capable of supplying working oil, which is a working fluid, from the pump units 24, an oil tank 68, and a fuel tank (not shown) for the engine are arranged in the equipment housing section 20. The pump unit 24 includes a gear case 70 connecting to a flywheel side of the engine 22, and a gear pump 72, which is a pilot pump for supplying working oil to switching pilot valves 28a, 28b (FIG. 1). The upper structure 18 is not limited to the structure described above, and it is possible, for example, to provide the drivers seat to one side in the lateral direction of the upper structure, and to provide an equipment housing section for holding an oil tank and engine and pump unit etc. on the other side in the lateral direction, with everything covered by a bonnet.

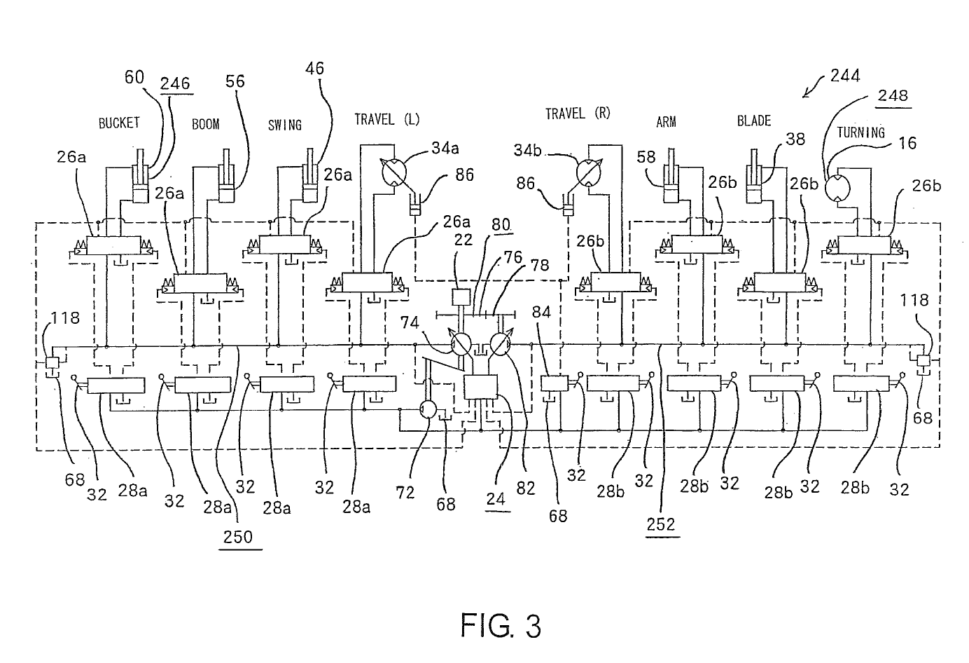

FIG. 3 is an overall diagram of the hydraulic circuits of the above-described excavator 10 (FIG. 1). Specifically, the excavator 10 is provided with the hydraulic circuit 244 for the working vehicle shown in FIG. 3. The hydraulic circuit 244 for the hydraulically powered working vehicle includes a plurality of types of actuator having a bucket cylinder 60, boom cylinder 56, swing cylinder 46, left side traveling motor 34a, right side traveling motor 34b, the arm cylinder 58, blade cylinder 38, and turning motor 16. As shown in FIG. 3, a first hydraulic pump 74, corresponding to a first variable capacity pump constituting the pump unit 24, and the gear pump 72, are coupled to an output shaft of an engine 22, and each of these pumps 74, 72 is capable of being driven by the engine 22. Also, power of the engine 22 is stepped up by a step up mechanism 80 comprised of a large diameter gear 76 and a small diameter gear 78 to be transmitted to a second hydraulic pump 82 corresponding to a second variable capacity pump constituting the pump unit 24, and the second hydraulic pump 82 can also be driven by the engine 22. Specifically, the first hydraulic pump 74 is operationally linked to the second hydraulic pump 82, capable of transmitting power using the step up mechanism 80, which is a pump drive gear. Also, the step up mechanism 80 includes the large diameter gear 76 and the small diameter gear 78, which are step up for stepping up the rotational speed of the second hydraulic pump 82 to be faster than the rotational speed of the first hydraulic pump 74. Therefore, the second hydraulic pump 82, which is a drive source for an actuator including the turning motor 16, is set so that a maximum value for discharge capacity per unit time becomes large compared to that of the first hydraulic pump 74.

Respective actuators constituted by the bucket cylinder 60, boom cylinder 56, swing cylinder 46 and a left side traveling motor 34a are connected in parallel to a first hydraulic pump 74 by way of respectively corresponding directional control valves 26a that are closed center type actuator switching valves. Also, respective actuators constituted by the arm cylinder 58, blade cylinder 38, turning motor 16 and a right side traveling motor 34b are connected in parallel to the second hydraulic pump 82 by way of respectively corresponding directional control valves 26b that are closed center type actuator switching valves. Specifically, cylinders and motors, being the above described plurality of types of actuator, are divided into two groups, being a first actuator group 246 including a bucket cylinder 60, boom cylinder 56, swing cylinder 46, and left side traveling motor 34a, and a second actuator group 248 including the right side traveling motor 34b, the arm cylinder 58, blade cylinder 38, and turning motor 16. The hydraulic circuit 244 for the working vehicle therefore includes a first circuit 250 having the first actuator group 246 and the first hydraulic pump 74 for driving the first actuator group 246, and a second circuit 252 having the second actuator group 248 and the second hydraulic pump 82 for driving the second actuator group 248. In this way, the above described actuators include each of the cylinders 60, 56, 46, 58 and 38 belonging to either the first actuator group 246 or the second actuator group 248.

Output ports of respective switching pilot valves 28a and 28b are connected to switching oil chambers provided on left and right ends of each of the directional control valves 26a, 26b. Each of the switching pilot valves 28a, 28b is also of closed center type, and respective input ports are connected in parallel to discharge ports of the gear pump 72. An suction port of the gear pump 72 is connected to the oil tank 68. Each of these switching pilot valves 28a, 28b is capable of being mechanically switched by operation elements 32 that are respectively correspondingly provided on peripheral parts of the driver's seat 30. If corresponding directional control valves 26a, 26b are switched hydraulically from a neutral position to an operating position by switching of each of the switching pilot valves 28a, 28b, extension or contraction of the corresponding cylinders 60, 56, 46, 58, 38, or rotational direction of the corresponding traveling motors 34a, 34b or the turning motor 16, is switched. Also, rotational direction of the turning motor 16 is switched by switching the directional control valve 26b corresponding to the turning motor 16. For example, by connecting the discharge port of the second hydraulic pump 82 to the turning motor 16 via the directional control valve 26b, the upper structure 18 (FIG. 1) can be laterally turned in a desired direction. The operation elements 32 can enable a swing operation of a lever in cross directions, and the instruction of operation amount of two different actuators can be made correspondent to the operation amount for respective directions of the operation element 32. Variable throttles for gradually increasing discharge flow rate to the actuators are provided at operating positions of the directional control valves 26a, 26b. Accordingly, opening amounts of the directional control valves 26a, 26b are arbitrarily adjusted in accordance with operation amounts of each switching pilot valve 28a, 28b.

Also, in order to vary inclination angle of variable swash plates of the left and right traveling motors 34a, 34b, which is inclination with respect to the motor shaft, at the same time, a single step up switching valve 84 is provided, and the step up switching valve 84 is connected to a discharge port of the gear pump 72. The step up switching valve 84 is capable of varying inclination angle of the variable swash plates of each of the traveling motors 34a, 34b into two stages. For example, by switching the step up switching valve 84 so that there is simultaneous supply and exhaust from the gear pump 72 to respective capacity changing actuators 86 that are connected to variable swash plates of the traveling motors 34a, 34b, the capacity of the traveling motors 34a, 34b is made large. On the other hand, by switching so that the oil inside the capacity changing actuator 86 is expelled to the oil tank 68, the capacity of the traveling motors 34a, 34b is made small. It therefore becomes possible to change the speed of each traveling motor 34a, 34b. The step up switching valve 84 is therefore provided common to each traveling motor 34a, 34b. The step up switch valve 84 is made capable of being switched by an operating element 32 that is a two speed switch lever, among the operating elements 32 provided at peripheral parts of the driver's seat 30 (FIG. 1).

Each traveling motor 34a, 34b is connected via a directional control valve 26a, 26b to a discharge port of a corresponding hydraulic pump 74, 82. Each of the switching pilot valves 28a, 28b for hydraulically switching the directional control valves 26a, 26b is capable of being switched, by an operation element 32 as a shift lever, among operation elements 32 provides at peripheral parts of the driver's seat 30 (FIG. 1), to connect the discharge port of a corresponding hydraulic pump 74, 82 to either of two ports of the traveling motors 34a, 34b, and is also capable of changing the supply oil amount to the traveling motors 34a, 34b. It is therefore possible to change between normal drive and reverse drive of each traveling motor 34a, 34b, respectively corresponding to forward and reverse, and to carry out speed regulation, by operation of the corresponding operation element 32.

By making feed amounts and feed directions the same by using operation elements 32 for switching the switching pilot valves 28a, 28b corresponding to the left and right traveling motors 34a, 34b, the working vehicle will travel in a straight line. Also, by making the feed amounts and feed direction different by independently operating the operation elements 32, outputs of each of the traveling motors 34a, 34b will be different and it is possible to turn the excavator 10 (FIG. 1).

With this embodiment, it is made possible to supply working oil from the first hydraulic pump 74 to the bucket cylinder 60, boom cylinder 56, swing cylinder 46 and left side traveling motor 34a, and to supply working oil from the second hydraulic pump 82 to the arm cylinder 58, blade cylinder 38, turning motor 16 and right side traveling motor 34b. The reason for this type of structure is to reduce the occurrence of pressure interference in the case where the different actuators are driven by the same hydraulic pump, in order to avoid actuators that have a high incidence rate of basically being used at the same time, being driven by the same hydraulic pump. Specifically, the bucket cylinder 60, boom cylinder 56, swing cylinder 46 and the left side traveling motor 34a have a low incidence rate of being used simultaneously. The arm cylinder 58, blade cylinder 38 and right side traveling motor 34b also have a low incidence of being used simultaneously. On the other hand, the turning motor 16 has a high incidence rate of being used at the same time as other actuators such as the arm cylinder 58, and it is necessary to reduce pressure interference in this case and to operate this actuator and the turning motor 16 at high speed, as well as it being necessary to prevent breakdown of smooth operation. In order to achieve this objective, a maximum value for discharge capacity per unit time of the second hydraulic pump 82 is made more than the maximum value for discharge capacity per unit time of the first hydraulic pump 74 using the step up mechanism 80, as described above. Also with this structure, it is not necessary to provide a separate pump dedicated to driving only the turning motor 16.

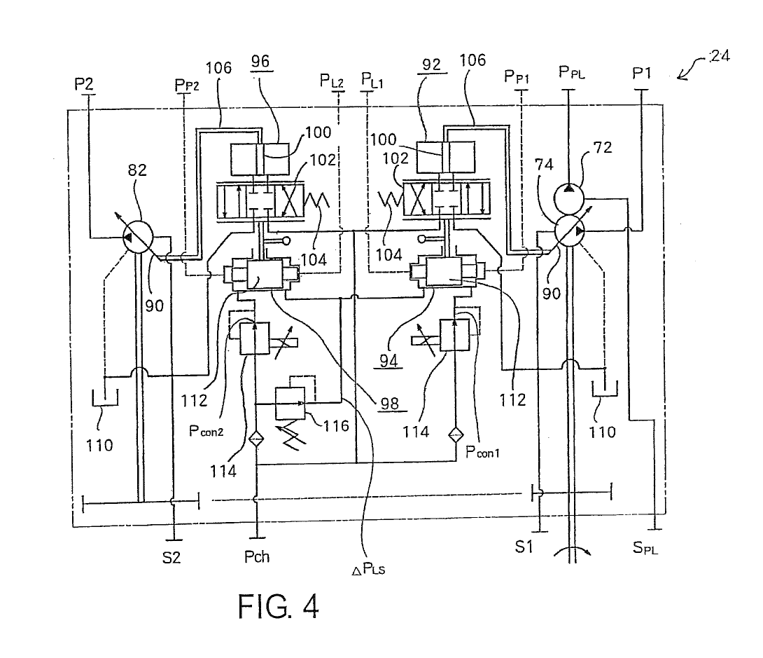

FIG. 4 is a drawing showing hydraulic circuits of the pump unit 24. The pump unit 24 includes the first hydraulic pump 74, which is a first variable capacity pump, a variable swash plate 90 for varying the capacity of the first hydraulic pump 74, a first servo mechanism 92, being a first swash plate operating section, and being a first servo piston unit, and a first balanced piston mechanism 94 connected capable of transmitting power to the first servo mechanism 92.

Also, the pump unit 24 includes the second hydraulic pump 82, which is a second variable capacity pump, the variable swash plate 90 for varying the capacity of the second hydraulic pump 82, a second servo mechanism 96, being a second swash plate operating section and being a second servo piston unit, and a second balanced piston mechanism 98 connected capable of transmitting power to the second servo mechanism 96.

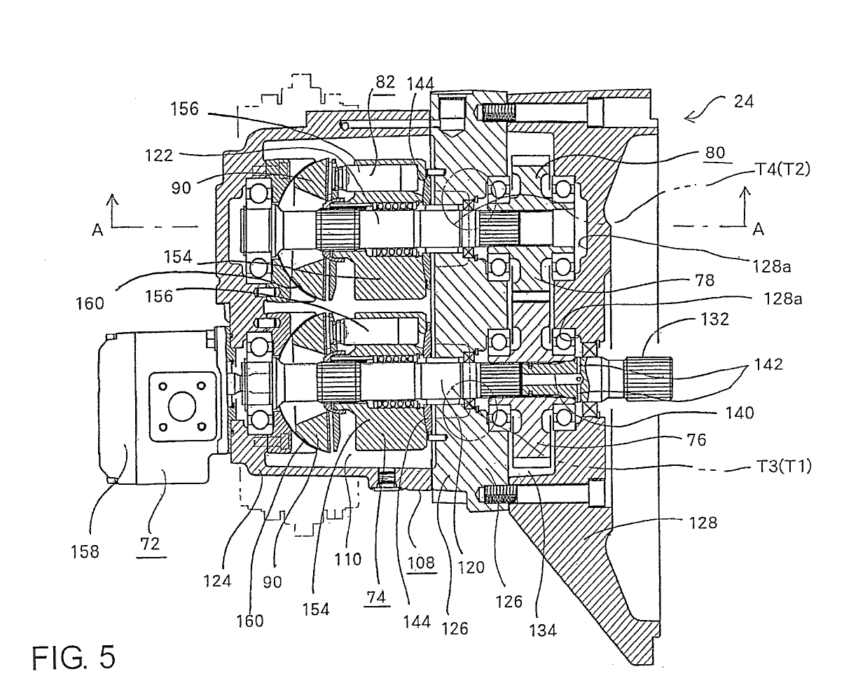

Each of the servo units 92, 96 includes a servo piston 100 provided capable of sliding in an axial direction at an inner side of a cylinder formed in an inner wall of the body of a pump case 108 (referred to FIGS. 5, 6, 8), that will be described later, and a spool 102 constituting a directional control valve provided capable of sliding in an axial direction relative to the inside of the servo piston 100. A spring 104, which is an urging member urging the spool 102 in one direction in the axial direction, is provided between the spool 102 and the servo piston 100. An operating pin 106 linked to the variable swash plate 90 is engaged with the servo piston 100, and the inclination angle of the variable swash plate 90 can be changed by movement of the servo piston 100.

If the spool 102 moves in one direction, working oil is discharged from the pressure receiving chamber at one side of the servo piston 100 to a oil reservoir 110 inside the pump case 108, and is discharged at pressure P_{PL}, from the gear pump 72, and working oil that has been adjusted to pressure Pch is introduced into the pressure receiving chamber at the other side of the servo piston 100. The servo piston 100 is therefore pressed by the pressure inside the pressure receiving chamber at the other side, and moves in one direction following the spool 102. Conversely, if the spool 102 moves in the other direction, working oil is discharged from the pressure receiving chamber at the other side of the servo piston 100 to the oil reservoir 110, and working oil that has been adjusted to pressure Pch is introduced into the pressure receiving chamber at the other side of the servo piston 100 from the gear pump 72. The servo piston 100 therefore moves in the other direction following the spool 102.

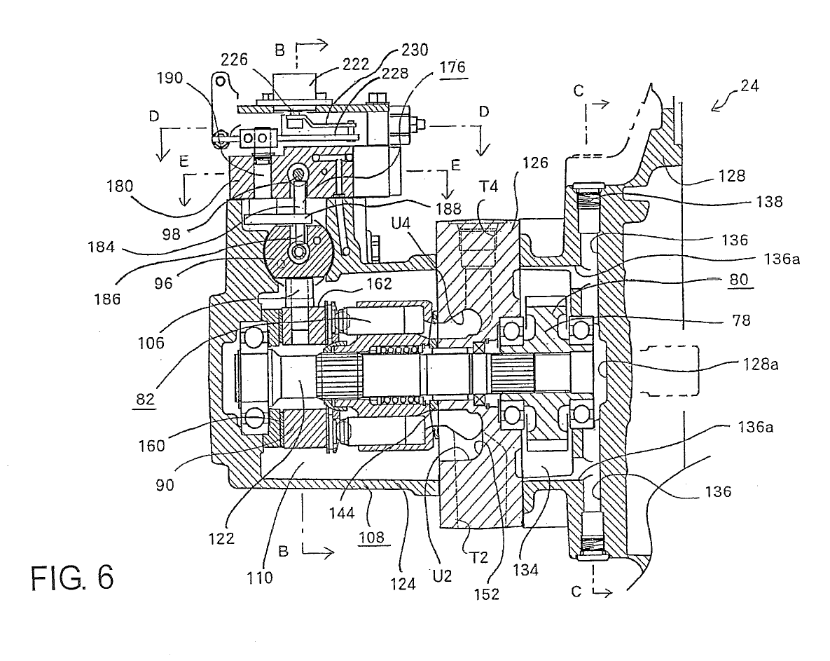

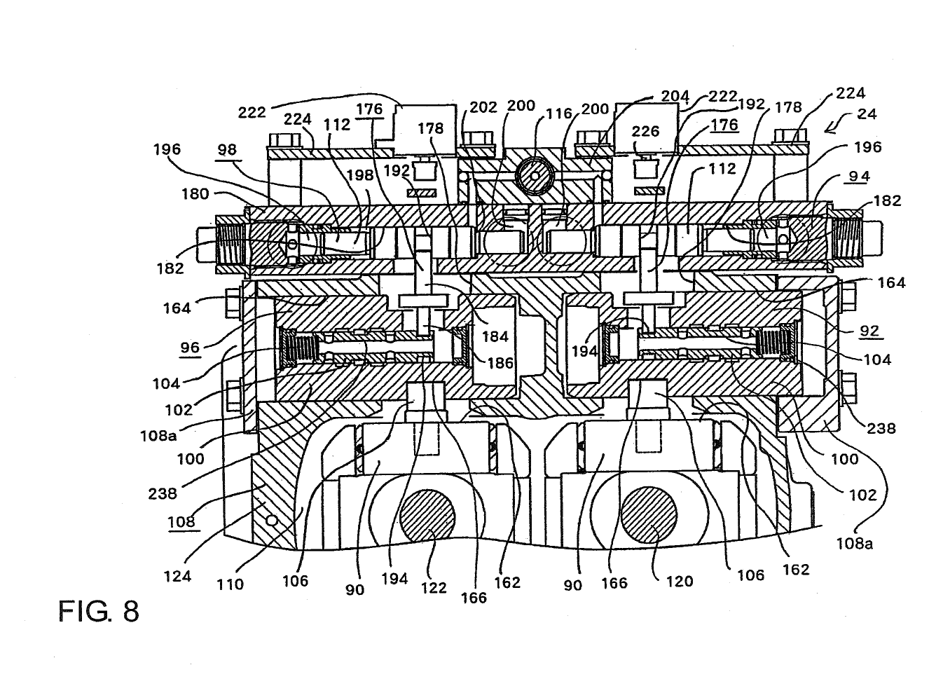

Also, each of the balanced piston mechanisms 94, 98 includes a piston body 112 provided capable of sliding in an axial direction inside a piston case 180 (refer to FIGS. 6, 8) which will be described later. Also, primary side pressure Pₚ₁(=P1), Pₚ₂(=P2) before passing through each of the directional control valves 26a, 26b, being discharge pressure of the corresponding hydraulic pump 74, 82, is introduced to a portion facing the small diameter section of one side, in the axial direction, of each piston body 112. Also, adjusted pressure P_{CON1}, P_{CON2} is capable of being introduced from a variable pressure reducing valve 114 that is capable of adjusting pressure reduction amount using input of electrical signals, connected to a discharge side of the gear pump 72, to a portion facing the large diameter portion of one side, in the axial direction, of each piston body 112.

Also, of secondary side pressures after passing through each of the directional control valves 26a, 26b (FIG. 3), namely load side pressure (load pressure), maximum load pressure P_{L1}, P_{L2} is introduced to a portion facing the small diameter section of the other side, in the axial direction, of each piston body 112. For example, it is made possible to introduce maximum load pressure to each balanced piston mechanism 94. 98 using circuit sections including a plurality of shuttle valves. Also, pressure ΔP_{LS} that has been adjusted to a desired pressure by a fixed pressure reducing valve 116, discharged from the gear pump 72 at pressure P_{PL}, is introduced to a section facing the large diameter section of the other end, in the axial direction of the piston body 112. The fixed pressure reducing valve 116 keeps pressure reduction amount constant at a previously set condition, namely, fixes the pressure reduction amount.

Inclination angle, which is inclination of the variable swash plates 90 of corresponding hydraulic pumps 74, 82 with respect to the pump shaft, is controlled so that the load sensing differential pressure (LS differential pressure), which is a differential pressure between primary side pressure P_{P1}, P_{P2}, before passing through the corresponding directional control valves 26a, 26b, and maximum load pressure P_{L1}, P_{L2}, becomes a desired previously set pressure, using each of the balanced piston mechanisms 94, 98. Specifically, the servo mechanisms 92, 96 are operated by the corresponding balanced piston mechanisms 94, 96 in accordance with variation in load sensing differential pressure, to cause variation in inclination angle of the variable swash plates 90 of the corresponding hydraulic pumps 74, 82. This will be described in detail later.

Returning to FIG. 3, each of the hydraulic pumps 74, 82 is put on standby, so that in an initial position the variable swash plate 90 (FIG. 4) maintains a small inclined state (for example, 2°) with respect to a plane that is orthogonal to the pump axis. As a result, at the time of driving the engine 22, even in a case where actuators such as all of the corresponding cylinders are not operated and the corresponding directional control valves 26a, 26b and a travel switching valve 88 are at a neutral position and closed, working oil is discharged slightly from the hydraulic pumps 74, 82. In association with this, in a case where an unloading valve 118 is respectively provided in passages at the discharge side of the hydraulic pumps 74, 82 and all of the corresponding directional control valves 26a (or 26b) and travel switching valve 88 are at the neutral position, the unloading valve 118 is opened and working oil is discharged to the oil tank 68. This unloading valve 118 is configured so that when the directional control valves 26a, 26b are in the operating position, output hydraulic pressure of the directional control valves 26a and 26b is introduced to the closed side of the unloading valve 118 as a switching signal, to prevent working oil discharge to the oil tank 68.

Next, a specific structure of the pump unit 24 of this embodiment will be described using FIG. 5 to FIG. 14. The pump unit 24 has the circuit structure shown in FIG. 4 described above. In the following description, elements that are the same as elements that were shown in FIG. 1 to FIG. 4 will be described with the same reference numerals attached.

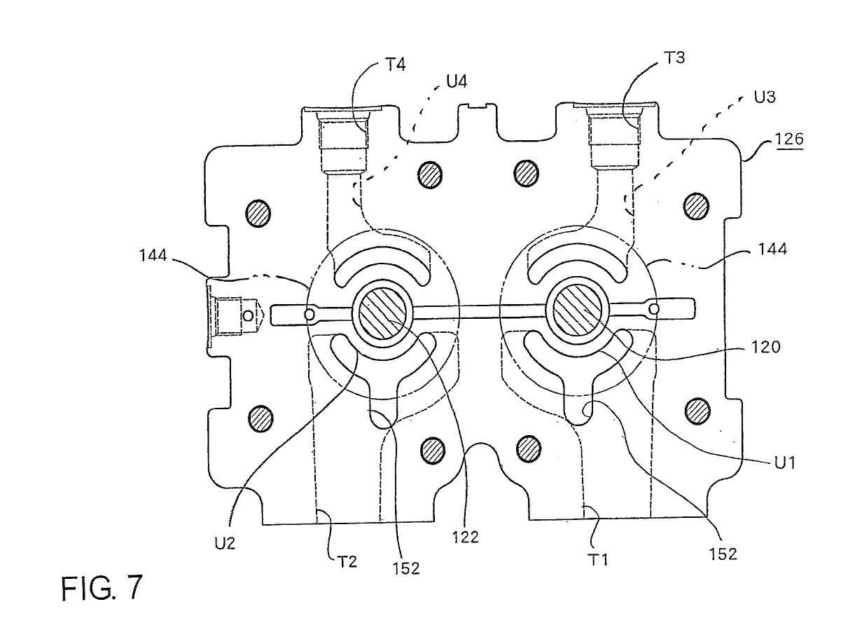

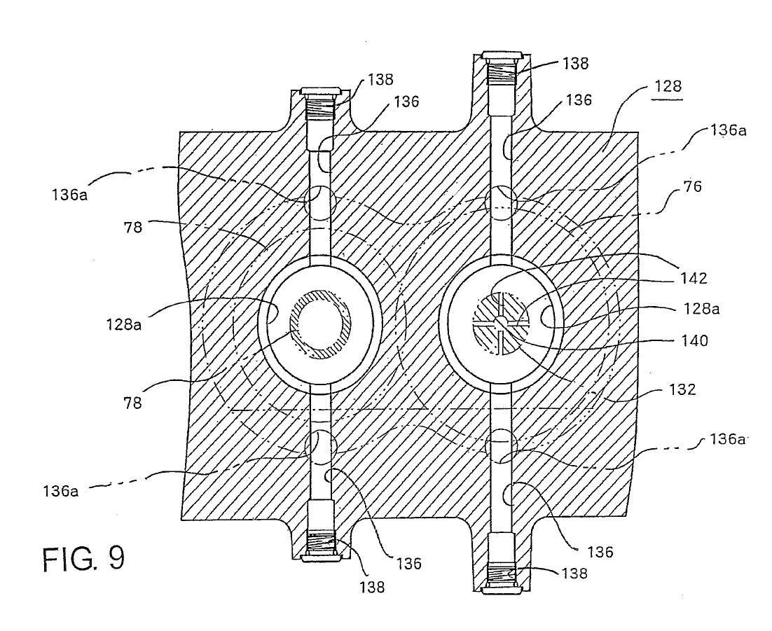

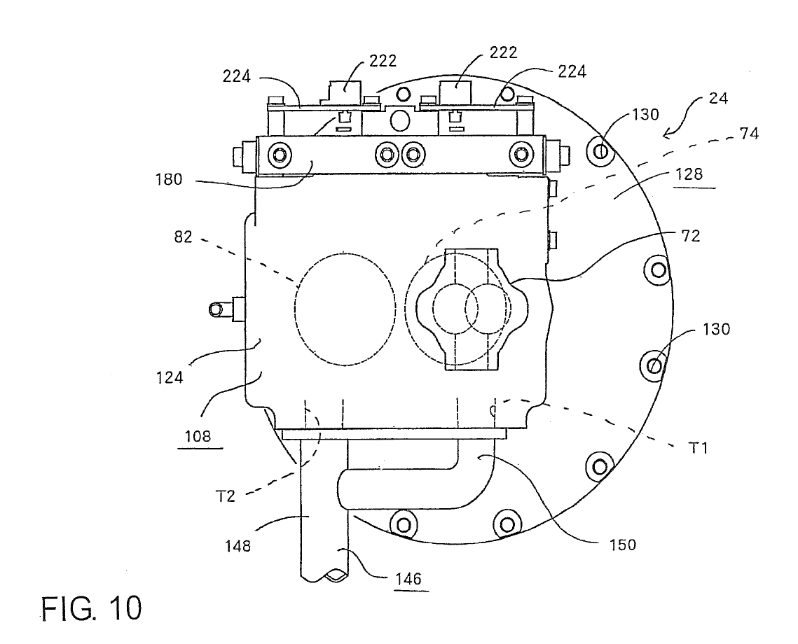

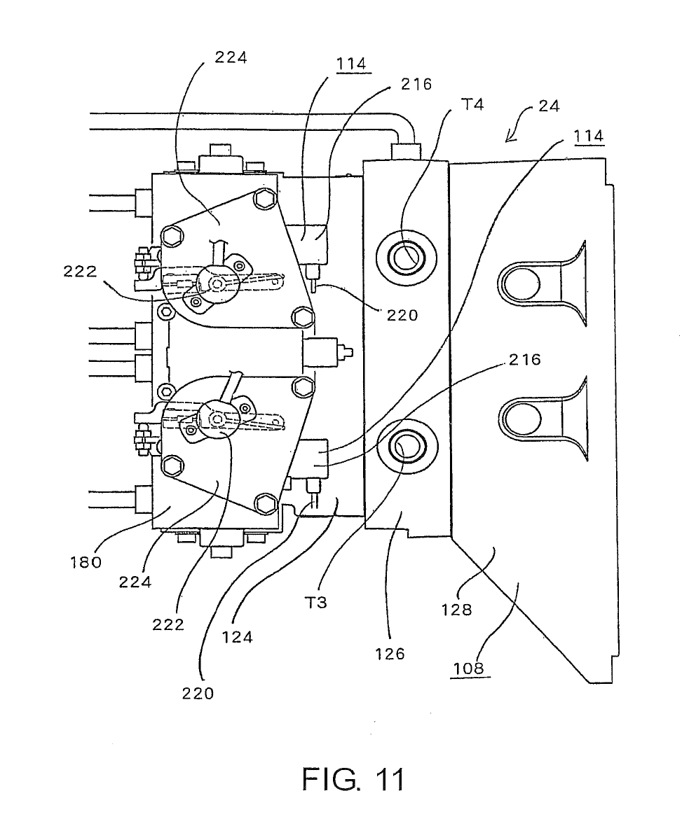

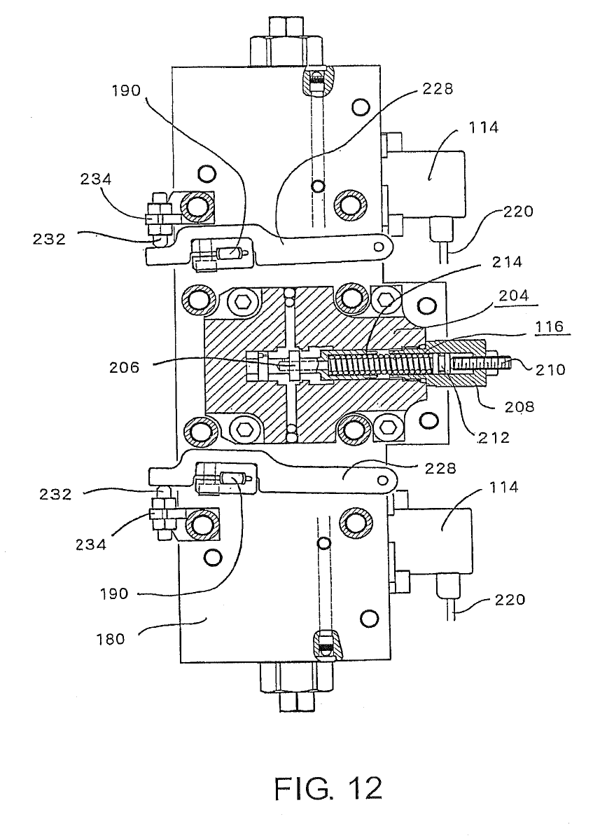

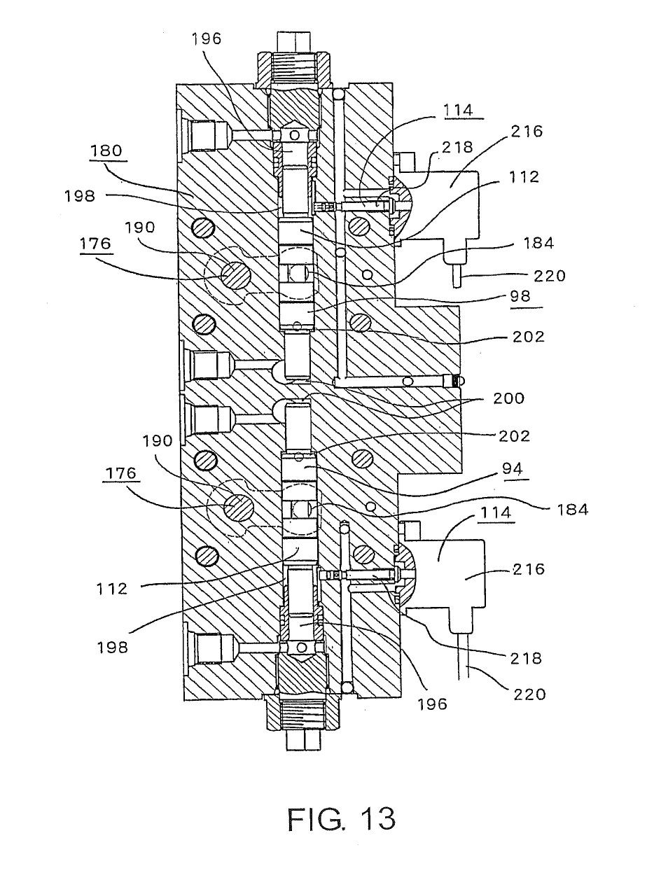

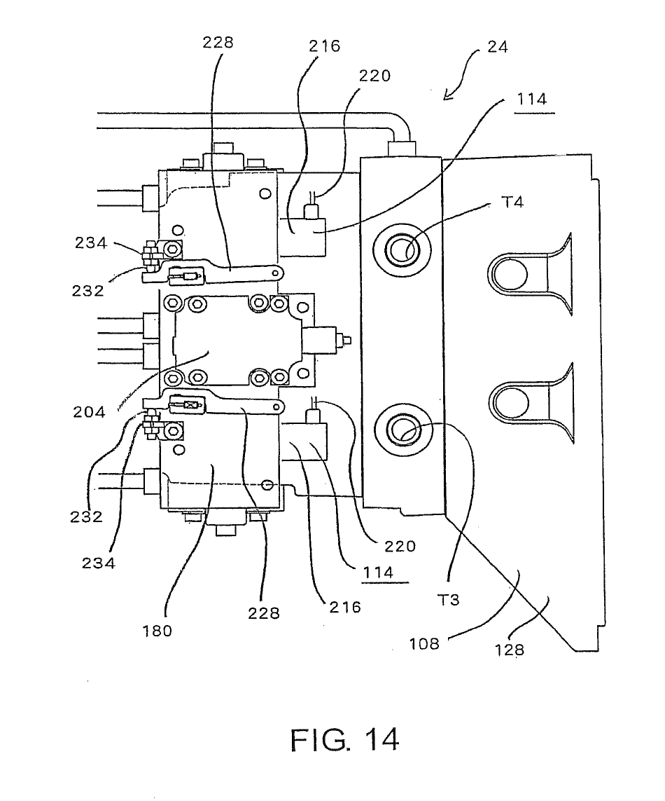

FIG. 5 is a transverse cross-sectional drawing of the pump unit 24. FIG. 6 is a cross-section along A-A in FIG. 5, and FIG. 7 is a drawing looking from the left side to the right side of FIG. 6, with a port block taken out of FIG. 6. FIG. 8 is a cross section along B-B in FIG. 6, and FIG. 9 is a cross sectional drawing along C-C of FIG. 6, with some parts omitted. FIG. 10 is a drawing looking from the left side to the right side of FIG. 6, and FIG. 11 is a drawing looking from the upper side to the lower side of FIG. 6. FIG. 12 is a cross sectional drawing taken along D-D of FIG. 6, and FIG. 13 is a cross sectional drawing taken along E-E of FIG. 6. FIG. 14 is a drawing showing an attachment state of a lever for rotational angle detection, showing a state where a rotational angle sensor and sensor support members have been omitted from FIG. 11.

As shown in FIG. 5, the pump unit 24 has two axial piston type variable capacity pumps, and comprises the pump case 108, the first hydraulic pump 74 and the second hydraulic pump 82, which are respective variable capacity pumps housed in the pump case 108, a first pump shaft 120 and a second pump shaft 122, and two variable swash plates 90. Also, as shown in FIG. 8, the pump unit 24 is provided with the first servo mechanism 92 and the second servo mechanism 96, the first balanced piston mechanism 94 and the second balanced piston mechanism 98, and the gear pump 72 (FIG. 5).

As shown in FIG. 5, the pump case 108 includes a case body 124 having an opening section at one end (right end of FIG. 5), a port block 126 that blocks off the opening section of the case body 124 and is a block that forms ports for carrying out oil supply and discharge for the first hydraulic pump 74 and the second hydraulic pump 82, and a gear case 128 provided with a horn shaped flywheel housing for enclosing a flywheel, coupled to a side of the port block 126 that is the opposite side to the case body 124. As shown in FIG. 6 and FIG. 7, a plurality of ports T1, T2, T3, T4 that pass through a kidney port, which will be described later, are formed in the upper surface and lower surface of the port block 126. Also, as shown in FIG. 5, both end sections of the first pump shaft 120 and the second pump shaft 122 are rotatably supported in the case body 124 and the port block 126, in a state with both being held and supported by bearings. As shown in FIG. 10, in the flywheel housing of the gear case 128, hole sections 130 are formed at a plurality of locations in circumferential direction around the outer periphery of the engine side end section, and the flywheel housing can be coupled to a mounting flange of the engine 22 (FIG. 2) by bolts (not shown) that are inserted into each hole section 130. In this embodiment the gear case 128 and the flywheel housing are integrally formed, but it is also possible to couple the two members so that they can be separated.

Also, as shown in FIG. 5, an input shaft 132 capable of linking to an output shaft of the engine 22 is rotatably supported by an bearing in the gear case 128, and positioned substantially in the middle, in the radial direction, of the flywheel housing. The first pump shaft 120 and the input shaft 132 are coaxially arranged, and are respectively spline fitted at an inner side of a central cylindrical shaft of the large diameter gear 76 constituting the step up mechanism 80. As a result, the first pump shaft 120 and the input shaft 132 are coupled capable of rotating in synchronization with the one another by means of the large diameter gear 76.

Also, the second pump shaft 122 is spline fitted to an inner side of a central cylindrical shaft of the small diameter gear 78 constituting the step up mechanism 80, with the large diameter gear 76 and the small diameter gear 78 meshing. As a result, the second hydraulic pump 82 is stepped up with respect to the first hydraulic pump 74 by the gear ratio of the step up mechanism 80. Those end sections of the central cylindrical shafts of each of the gears 76, 78 are rotatably supported in the port block 126 and the gear case 128 by respective bearings. In this way, it is also possible to adopt a structure in which, in the pump unit 24 for driving two or more pumps 74, 82 simultaneously, a plurality of gears 76, 78 of a mechanism, such as of the step up mechanism 80, are supported respectively at both ends in pump case 108, and also each pump shaft 120, 122 is supported respectively at both ends in pump case 108, and corresponding pump shafts 120, 122 and associated gears 76, 78 are coupled. This should therefore lead to improvement in strength and durability of the pump shafts 120, 122 and gears 76, 78, and makes maintenance operations of the hydraulic pumps 74, 82 easier.

An oil reservoir 110, which is a pump side space, is provided at an inner side of the pump case 108, and a gear side space 134 is provided at an inner side of the gear case 128 where the step up mechanism 80 is arranged, with the oil reservoir 110 and the gear side space 134 being independent of one another. In this way, it is possible to adopt a structure where, in the pump unit 24 for driving two or more pumps 74, 72 simultaneously, the gear side space 134, being a chamber for housing gears 76, 78 linked to each of the pumps 74, 82, and the pump side space, being a chamber for housing each of the pumps 74, 82, are made independent of one another, with oil circulation between the two being impossible. This will result in a reduction in loss of power for driving each of the pumps 74, 82. On the one hand oil is filled into the oil reservoir 110, and on the other hand the amount of oil put in the gear side space 134 with sealed up is reduced. For example, in FIG. 5 oil put in the gear side space 134 is an amount in which lower ends of each of the gears 76, 78 are immersed.

Also, as shown in FIG. 6 and FIG. 9, in a support wall opening onto the gear side space 134 of the gear case 128, oil holes 136 vertically penetrating through bearing support indents 128a of the gear case 128 are formed. In each oil hole 136, upper and lower end sections that are open to an outer surface of the gear case 128 are blocked off by a detachable plug 138. Each oil hole 136 leads to the gear side space 134 by way of tunnels 136a formed so as to be opposite upper and lower positions of peripheral tooth tips of each gear 76, 78. Supply and discharge of oil to the gear side space 134 by means of each oil hole 136 and the tunnels 136a therefore becomes possible in a state where the upper plug 138 has been removed.

As shown in FIG. 5, the axial direction hole 140 opening to one end surface (right end surface in FIG. 5) side of the first pump shaft 120, and a radial direction hole 142, leading to the axial direction hole 140 and formed radially, are provided in the input shaft 132 for coupling to the engine 22 (FIG. 2). An outer end part of the radial direction hole 142 is opened to the bearing support indent 128a. As a result, as shown in FIG. 9, oil inside the gear side space 134 passes from the tunnel 136a under the action of the gear pump, through the oil hole 136 to reach the axle bearing support indent 128a when each of the gears 76, 78 are rotated, and can be supplied from each of the holes 140, 142 of the input shaft 132 to a spline section between one end outer surface of the first pump shaft 120 (FIG. 5) and an inner surface of the large diameter gear 76 (FIG. 5). It is therefore possible to effectively improve durability of the spline section. Since one end surface (right end surface in FIG. 5) of the small diameter gear 78 side of the second pump shaft 122 similarly opens to the bearing support indent 128a, it becomes possible to sufficiently lubricate the spline section between one end outer surface of the second pump shaft 122 and an inner surface of the small diameter gear 78 using oil that has passed through the tunnel 136a and the oil hole 136 and has been discharged inside the axle bearing support indent 128a.

Next, each of the hydraulic pumps 74 and 82 will be described. Each of the hydraulic pumps 72 and 82 comprises a cylinder block 154 capable of rotating integrally with the pump shafts 120 and 122 as a result of being spline engaged with the pump shafts 120 and 122, a plurality of pistons 156 housed to be capable of reciprocating in the cylinder of the cylinder block 154, and a spring provided between an inner surface of the cylinder block 154 and outer surfaces of the pump shafts 120 and 122. The spring has a function to press a shoe supported on one end of each piston 156 by a washer to the variable swash plate 90 side by means of a pin that has a spherical outer surface.

Also, each of the hydraulic pumps 74, 82 includes a valve plate 144 supported so as to prevent surface direction offset, at one surface side (left side in FIG. 5) of the port block 126. The valve plates 144 have respective substantially arc shaped suction ports and discharge ports, that penetrate in a direction parallel to the respective pump shafts 120, 122 at both sides in the vertical direction. The suction ports lead to intake oil passages U1, U2 formed at a lower side of the port block 126 in a state mounted in a vehicle shown in FIG. 7, and the discharge ports lead to discharge oil passages U3, U4 formed at an upper side of the port block 126 shown in FIG. 7. Kidney ports opening to one surface of the port block 126 are provided at one end of each of the oil passages U1, U2, U3, U4, and lead to suction ports or discharge ports of the respective valve plate 144. Input ports T1, T2 and output ports T3, T4, being respectively for the first hydraulic pump 74 (FIG. 5) or for the second hydraulic pump 82 (FIG. 5), are opened at both sides, in a width direction (lateral direction in FIG. 7), of the lower surface and the upper surface of the port block 126. With this type of structure, in the pump unit 24 (FIG. 6) working oil is taken in from the lower side and working oil is discharged from the upper side. In this way, in the pump unit 24 for driving two or more pumps 74, 82 simultaneously, since the respective input ports T1, T2 are used attached to the working vehicle so as to be arranged downwards and the output ports T3, T4 are used attached to the working vehicle so as to be arranged upwards, it is easy to carry out operations to attach valve piping to the pump unit 24.

Also, in order to supply oil to each input port T1, T2, it is possible to connect supply piping 146 to the pump unit 24, as shown in FIG. 10. An end section at an opposite side to the side of the supply piping 146 that connects to the pump unit 24 is connected to an external oil tank 68 (FIG. 2). Also, at the side connecting to the pump unit 24, the supply piping 146 branches into a body section 148, and a small diameter section 150 has a diameter that is smaller than the diameter of the body section 148. The body section 148 is provided in a substantially straight shape at least at the pump unit 24 connection side. An upper end section of the small diameter section 150 is connected to the first hydraulic pump 74 side input port T1, while an upper end section of the body section 148 is connected to the second hydraulic pump 82 side input port T2. Connecting large diameter piping to the second hydraulic pump 82 side, and connecting small diameter piping to the first hydraulic pump 74 side, is in order to handle required intake oil amount by making rotation of the second hydraulic pump 82 faster than the first hydraulic pump 74 using the step up mechanism 80 (FIG. 5), and making discharge capacity per unit time at the second hydraulic pump 82 larger than the first hydraulic pump 74. As the supply piping, it is possible to not use this type of branched structure, and instead connect two supply pipes of differing internal diameters independently of one another to each of the input ports T1 and T2.

In this way, in a pump unit 24 for simultaneously driving 2 or more pumps 74, 82 of differing discharge capacities, it is possible to adopt a structure where a body section 148, being supply piping for the large discharge capacity hydraulic pump 82, is provided in a straight shape, and the small diameter section 150, being supply piping for the small discharge capacity hydraulic pump and 74, is branched from the body section 148. It is therefore possible to effectively prevent the occurrence of cavitation inside the supply piping 146 even if the intake flow rate at the large discharge capacity hydraulic pump 82 is larger than that of the small discharge capacity hydraulic pump 74.

Also, as shown in FIG. 6 and FIG. 7, extended sections 152 extending to a position outside the lower side of the valve plate 144 are provided at intermediate portions of the kidney port, being arched opening sections in the intake oil passages U1, U2 opening towards the valve plate 144 side of the port block 126. A lower-end part of the extended section 152 passes through one end opening of the case body 124, and leads to the oil reservoir 110. As a result, even if oil leaks out from elements inside the case body 124, such as each hydraulic pump 74, 82, and accumulates in the oil reservoir 110, it passes through the extended section 152 and is immediately taken in from the suction port of the valve plate 144. In this way, in a pump unit 24 for simultaneously driving two or more pumps 74, 82, it is possible to adopt a structure in which suction ports of each hydraulic pump 74, 82 are in communication with the inside of the pump case 108 where oil that has leaked from a plurality of pumps 74, 82 accumulates. As a result, surplus oil inside the pump case 108 does not need to be returned through piping etc. to a reservoir tank, piping can be omitted or reduced, and reduction in cost is achieved by reducing the number of components.

Also, a case 158 of an external gear pump 72 is fixed to the outer surface of the case body 124, and the gear pump shaft of the gear pump 72 is coupled to the first pump shaft 120 at an inner side of the pump case 108. A drive gear (or inner rotor) is also fixed to the gear pump shaft. The gear pump 72 can be made a pump where a driven gear meshes with a drive gear, or a trochoid pump where an outer rotor rotates in an eccentric manner with respect to the inner rotor. Although omitted from the drawings, the gear pump shaft projects from an outer surface of the case 158 of the gear pump 72, and it is also possible to provide a power transmission section for coupling to another unit on this protruding portion. For example, it is possible to configure a power transmission section by forming a male spline section or female spine section on an end part of the gear pump shaft. It is possible, for example, to spline couple a rotating shaft of a cooling fan, not shown, to this power transmission section.

Also, as shown in FIG. 5, FIG. 6, and FIG. 8, each variable swash plate 90 is capable of having its inclination angle changed by a corresponding servo mechanism 92, 96, being a swash plate operations section. Each variable swash plate 90 has a convex surface portion 160 having an arc shaped cross-section, which is at a side surface opposite to each piston 156, and an upper surface section 162 facing upwards. A concave surface section having an arc shaped cross-section for aligning with the convex surface portion 160 is provided on a fixed member which is fixed to the case body 124, and the convex surface portion 160 is capable of sliding along the concave surface section. As shown in FIG. 8, an operating pin 106 is coupled to the upper surface section 162 in a vertical direction, and the operating pin 106 engages with a servo piston 100 constituting the servo mechanisms 92, 96.

Each of the servo mechanisms 92 and 96 is made up of a hollow servo piston 100 capable of sliding in an axial direction inside a cylinder 164 that is parallel to a direction orthogonal to each pump shaft 120, 122, a spool 102, which is a directional control valve provided capable sliding in an axial direction at an inner side of the servo piston 100, and a spring 104 which is an urging member for urging the spool 102 toward one direction, in the axial direction with respect to the servo piston 100, on the spool 102. Each servo piston 100 includes a latching groove 166, which is a latching section for engaging with an operating pin 106 coupled to a corresponding variable swash plate 90, on the outer surface of the servo piston 100, and a plurality of internal oil passages. The latching groove 166 is provided in a direction orthogonal to the axial direction of the cylinder 164.

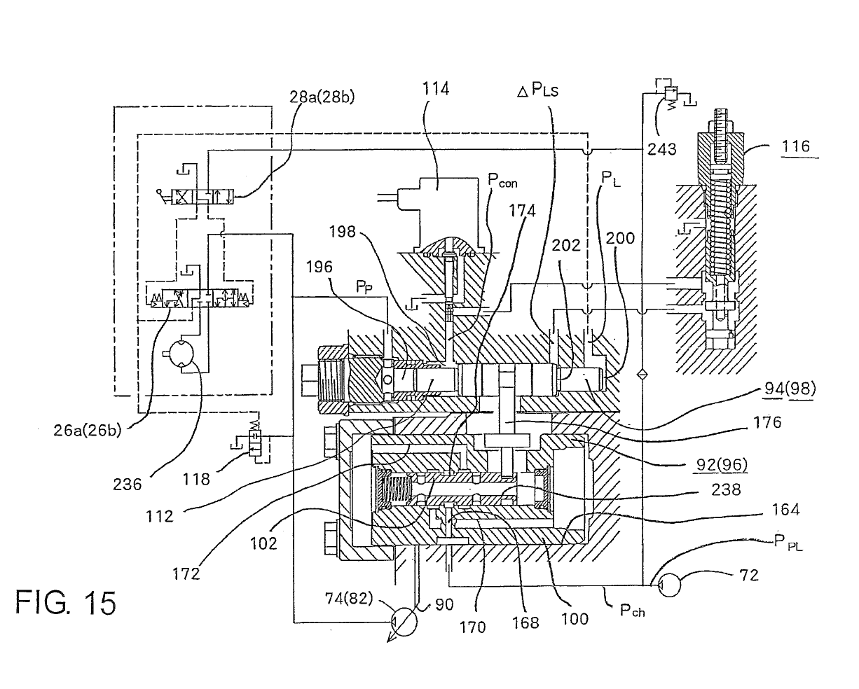

FIG. 15 is a drawing for explaining operation of a balanced piston mechanism 94 (98) for driving a servo mechanism 92 (96) in the pump unit 24. As shown in FIG. 15, a first oil passage 168, a second oil passage 170, and a third oil passage 172 are provided in the servo piston 100. The first oil passage 168 is connected to an oil passage that is connected to a discharge port of the gear pump 72, and has a function to introduce specified adjusted pressure from an outer surface side of the piston 100 to an inner surface side of the piston 100. Also, the second oil passage 170 has one end open to a position, at the inner surface of the piston 100, that is offset to one side (the left side in FIG. 15) in the axial direction of the piston 100, with respect to a piston 100 side opening end of the first oil passage 168, and has the other end open to another end surface (right end surface in FIG. 15), in the axial direction, of the piston 100. Also, the third oil passage 172 has one end open to a position, at the inner surface of the piston 100, that is offset to the other side (the right side in FIG. 15) in the axial direction of the piston 100, with respect to a piston 100 side opening end of the first oil passage 168, and has the other end open to the one end surface (left end surface in FIG. 15), in the axial direction, of the piston 100.

The spool 102 has an annular groove section 174 on an outer surface, and the groove section 174 is permitted to simultaneously face the opening of the first oil passage 168 that is at the inner surface side of the piston 100, and the one end opening of the second oil passage 170 or the third oil passage 172. The groove section 174 has a function to switch between a state where the first oil passage 168 and the second oil passage 170 communicate, and a state where the first oil passage 168 and the third oil passage 172 communicate. Also, the servo mechanisms 92, 96 comprise arm members 176 which are intermediate latching members that allow the spool 102 to move in synchronization with movement of the piston body 112 in the axial direction, provided between the spool 102 and the piston body 112 constituting the corresponding balance piston mechanism 94, 98.

Also, the spool 102 has an oil passage 238 provided at an inner side, and the oil passage 238 always communicates with the oil reservoir 110 inside the case body 124 of FIG. 6. The oil passage 238 communicates with the third oil passage 172 in a state where the first oil passage 168 and the second oil passage 170 are in communication by way of the groove section 174, and communicates with the second oil passage 170 in a state where the first oil passage 168 and the third oil passage 172 are in communication by way of the groove section 174.

As shown in FIG. 8, each servo mechanism 92, 96 is contained in an internal space in an upper part of the case body 124, and is provided with an opening section 178 in order to allow an upper end portion of the arm member 176 to project to an upper part of the respective inner space. Also, a piston case 180 is coupled to an upper side of the case body 124 by bolts, which are fastening members. The first balanced piston mechanism 94 and the second balanced piston mechanism 98 respectively facing each servo mechanism 92, 96 are then contained in the piston case 180. Each balanced piston mechanism 94, 98 is linked to a spool 102 of a corresponding servo mechanism 92, 96 and capable of moving in synchronization with the spool 102, and includes a cylinder 182, and a piston body 112 that is provided capable of sliding in the axial direction inside the cylinder 182. The arm member 176 is provided between the spool 102 of each servo mechanism 92, 96 and the corresponding piston body 112.

As shown in FIG. 6, the arm member 176 includes an upper shaft 184 and a lower shaft 186 that are provided on the same axis in the vertical direction, a flange 188 coupled between the two shafts 184 and 186, and a support shaft 190 that is put up in the vertical direction on the tip end upper surface of the flange 188. As shown in FIG. 8, the upper shaft 184 engages with the locking groove 192 that is provided all around the intermediate section of the piston body 112, while the lower shaft 186 engages with the locking groove 194 that is provided all around the intermediate section of the spool 102. With this structure, it is made possible for the spool 102 of the servo mechanisms 92, 96 to move in synchronization with movement in the axial direction of the piston body 112 of the corresponding balanced piston mechanism 94, 98.

Also, each of the balanced piston mechanisms 94, 98 comprises a first pressure receiving chamber 196 and a fourth pressure receiving chamber 198 provided at one inside, in the axial direction, of the cylinder 182, and a second pressure receiving chamber 200 and a third pressure receiving chamber 202 provided at the other end side, in the axial direction, of the cylinder 182. A primary side working oil pressure P_{P} before passing through the directional control valves 26a, 26b (FIG. 3), being actuator switching valves, is introduced to the first pressure receiving chamber 196, the primary side operating pressure P_{P} being discharge pressure of each of the first and second hydraulic pumps 74, 82, which are variable capacity pumps, and a maximum load pressure P_{L} (hereafter simply referred to as “load pressure P_{L}”) after passing through the directional control valves 26a, 26b is introduced to the second pressure receiving chamber 200. Also, a set load sensing pressure ΔP_{LS} is introduced to the third pressure receiving chamber 202. The set load sensing pressure ΔP_{LS} is a set pressure that is set in advance, equivalent to working fluid differential pressure arising before and after passing through the directional control valves 26a, 26b, in a steady-state of an operating position of the directional control valves 26a, 26b. As shown in FIG. 15, pressure Pch acquired through adjustment of the discharge pressure P_{PL} of the gear pump 72 is reduced to a desired value by a fixed pressure reducing valve 116, so as to acquire the set load sensing pressure ΔP_{LS}.

Also, as shown in FIG. 8, on an upper surface of the piston case 180 a valve case 204 is fixed at a position facing the upper side of width direction intermediate section between two associated balanced piston mechanisms 94, 98. As shown in FIG. 12, the fixed pressure reducing valve 116 that is common to each of the balanced piston mechanisms 94, 98 (FIG. 8) is provided in the valve case 204. The fixed pressure reducing valve 116 comprises a cylinder, a valve body 206 that is provided capable of sliding with respect to the cylinder, a cap 208 fixed to the valve case 204, a screw shaft 210 screwed into the cap 208, a spacing seat 212 that is pressed by the screw shaft 210, and a spring 214 provided between the valve body 206 and the spacing seat 212, with the valve body 206 being urged in one direction by the spring 214. Pressure Pch from the gear pump 72 (FIG. 15) is introduced to a space in which the valve body 206 arranged by way of an oil passage, not shown, of the valve case 20. The pressure Pch is reduced in response to urging of the spring 214, and the set load sensing pressure ΔP_{LS} is introduced to each of the third pressure receiving chambers 202 (FIG. 8) by way of an oil passage. As shown in FIG. 12, the pressure reduction amount by the fixed pressure reducing valve 116 is capable of adjustment by changing the urging force of the spring 214 by adjusting the amount of ingress of the screw shaft 210 to the inner side of the cap 208.

As shown in FIG. 13, the fourth pressure receiving chamber 198 is capable of introducing a variable pressure, after the discharge pressure of the gear pump 72 (FIG. 15) has been reduced, using a corresponding proportional control type variable pressure reducing valve 114. Specifically, to the fourth pressure receiving chamber 198, an arbitrarily set variable pressure is introduced. At the time of normal operation it is possible to cut off working oil introduced from the gear pump 72 to the fourth pressure receiving chamber 198. Each variable pressure reducing valve 114 has a proportional solenoid 216 and a pressure reducing valve body 218 for controlling pressure reduction amount using the proportional solenoid 216, and a signal representing the load of the engine 22 (FIG. 2), for example, is input to the proportional solenoid 216. When the engine load is high, the proportional solenoid 216 lowers the reduction amount for secondary side pressure P_{CON} using the pressure reducing valve body 218, and regulates pressure reduction amount so that a pressure close to pressure Pch is introduced to the fourth pressure receiving chamber 198. Also, the proportional solenoid 216 is fixed in a state protruding from a side surface of the piston case 180 that faces in a horizontal direction. A cable 220 for inputting command signals is also connected to the proportional solenoid 216.

In this way, in a pump unit 24 for simultaneously driving to or more variable capacity pumps, when mounted in a working vehicle servo mechanisms 92, 96 respectively linked to variable swash plates 90 are provided at an upper part of a case body 124, and a piston case 180, being a member for housing the balanced piston mechanisms 94, 98, is provided at an upper side of the servo mechanisms 92, 96. It is therefore possible to easily carry out maintenance operations by opening a bonnet that is generally provided on the equipment housing section 20 (FIG. 1).

Also, as shown in FIG. 8, a rotation angle sensor 222, which is two potentiometers respectively corresponding to each variable swash plate 90 is provided in order to detect the inclination angle of each variable swash plate 90. For this configuration, at an upper side of the piston case 180 sensor support members 224 are bolt fastened using bolts, which are fastening members, at two positions facing the upper side of each balanced piston mechanism 94, 94. Each sensor support member 224 is respectively fixed at an upper side of the piston case 180 and the valve case 204. The rotational angle sensor 222 is fixed to an upper side of each sensor support member 224, and a sensor shaft 226 is oriented in a vertical direction. A lower end of the sensor shaft 226 projects downward from a lower surface of the sensor support member 224.

On the other hand, as has been described above, the arm member 176 that is engaged between each servo mechanism 92, 96 and a corresponding balanced piston mechanism 94, 98 has the support shaft 190 (FIG. 6). The support shaft 190 passes through a hole section that penetrates the piston case 180 in a vertical direction and projects to an upper side of the piston case 180, and an intermediate section of a first lever 228, which is a lever for rotation angle detection, is coupled to this protruding portion. Also, one end section of a second lever 230, which is a lever for rotation angle detection, is swingably supported on a tip end part of the first lever 228 by a pin. The other end section of the second lever 230 is fastened to a lower end section of the sensor shaft 226. As a result, if the inclination angle of the variable swash plate 90 is varied and the spool 102 moves following the servo piston 100, the upper shaft 184 and lower shaft 186 of the arm member 176 move in a perpendicular direction to sheet of FIG. 6, and accordingly the support shaft 190 rotates about a hole section of the piston case 180 and each of the first lever 228 and the second lever 230 swings, and the sensor shaft 226 of the rotational angle sensor 222 rotates. As a result, it becomes possible to detect rotation angle corresponding to inclination angle of the variable swash plate 90 using the rotational angle sensor 222. A rotation angle sensing unit is constituted by each of the levers 228, 230 that are coupled by the pin, and the rotational angle sensor 222. In this way, in the pump unit 24 simultaneously driving two or more variable capacity pumps, it is possible to adopt a structure in which two or more support shafts 190, that are rotatably supported on the pump case 108 or to members fixed to the pump case 108, are provided, and each support shaft 190 is linked to a corresponding rotational angle sensor 222, and it is made possible to detect rotation that is linked to movement of the corresponding variable swash plate 90.

Also, as shown in FIG. 12 and FIG. 14, an end part of a screw shaft 232 for initial position setting in the horizontal direction abuts against an end section of each first lever 228 at the side (left side in FIG. 12) that is opposite to the second lever 230 coupling side (FIG. 6). Each screw shaft 232 functions as a stopper, and by passing through the plate section 234 put up on a fixed member fixed on the upper surface of the piston case 180 and fastening with nuts from both sides, it becomes possible to adjust the amount of projection of the screw shaft 232 with respect to the plate section 234. As a result, it is possible to arbitrarily set the initial inclination angle which is the initial position of the variable swash plate 90 (FIG. 5), and even when the actuator 236 such as a motor is inactive with an operation element 32 such as an operation lever or pedal (FIG. 3) at a neutral position, the unit is on standby so that working oil is discharged slightly from each hydraulic pump 74, 82.

A detection value of the rotation angle sensor 222 shown in FIG. 11 is input to a controller, not shown. If the controller determines that the inclination angle of the variable swash plate 90 (FIG. 5) has become larger than a predetermined threshold value, a command signal to perform control so that pressure reduction amount by the pressure reducing valve body 218 is made smaller is output to the proportional solenoid 216. In this way, regulation is performed such that a large pressure is introduced to the fourth pressure receiving chamber 198 (FIG. 13), and the inclination angle of the variable swash plate 90 is maintained within a desired range.

Engine rotation speed is also input to the controller from the engine 22, and if the controller determines that load of the engine 22 has become higher than a predetermined threshold value, a command signal to perform control so that pressure reduction amount by the pressure reducing valve body 218 is made smaller is output to the proportional solenoid 216. In this case, inclination angle of the variable swash plate 90 is controlled so that inclination angle of the variable swash plate 90 is made smaller, and load on the engine 22 become smaller.

Next, the effects obtained from this embodiment will be described using FIG. 15. FIG. 15 schematically shows a connection relationship between a servo mechanism 92 (or 96), a balanced piston mechanism 94 (or 98), and an actuator with respect to a pump 72, 74. Also, one actuator 236, like a motor, is shown, but this is for simplification of the description and in actual fact, as shown in FIG. 3, working oil is supplied from the gear pump 72 to a plurality of actuators that are connected in parallel, such as cylinders like the bucket cylinder 60, and motors such as the traveling motor 34a corresponding to the servo mechanism 92 (or 96) and the balanced piston mechanism 94 (or 98). In the following description, description is given taking the case where inclination angle of the variable swash plate 90 all the first hydraulic pump 74 is controlled as a typical example, but the case of the second hydraulic pump 82 is also the same. As shown in FIG. 15, the inclination angle of the variable swash plate 90 is controlled by the servo mechanism 92, the balanced piston mechanism 94, the variable pressure reducing valve 114 and the fixed pressure reducing valve 116.

Pressure Pch that has been adjusted from the discharge pressure P_{PL} of the gear pump 72 is introduced to the first oil passage 168 of the servo piston 100. Primary working oil pressure P_{P} before passing through the directional control valve 26a is introduced to the first pressure receiving chamber 196 of the balanced piston mechanism 94. Secondary load pressure P_{L} after passing through each directional control valve 26a is introduced to the second pressure receiving chamber 200. A set load sensing pressure ΔP_{LS}, that has been acquired by reducing the pressure Pch using the fixed pressure reducing valve 116, is introduced to the third pressure receiving chamber 202. Pressures applied to both sides of the piston body 112 are made to balance under the following conditions.

(Primary side pressure P_{P})=(set load sensing pressure ΔP_{LS})+(load pressure PL)

At the time of engine startup, if the pumps 72, 74 are driven with pressure P_{CON} due to the variable pressure reducing valve 114 at zero and the closed center type directional control valves 26a in the neutral position, then as shown in FIG. 15, the primary pressure Pp (unloading pressure) acts on the first pressure receiving chamber 196, and the set load sensing pressure ΔP_{LS} acts at the third pressure receiving chamber 202. Since the load pressure P_{L} that acts on the second pressure receiving chamber 200 is 0, P_{P}>ΔP_{LS}+P_{L} results, and the piston body 112 is moved to the illustrated position. When the piston body 112 is at this position, further movement of the piston body 112 by the previously described arm member 176 (FIG. 8), support shaft 190, and screw shaft 232 (FIG. 12) in the rightward direction of the sheet of FIG. 15 is prevented as a stopper, the servo piston 100 follows the spool 102 of the servo mechanism 92 that is linked to the piston body 112, and the variable swash plate 90 is tilted and held so as to maintain oil amount discharged from the hydraulic pump 74 at a stipulated minimum value.

Next, when the directional control valves 26a are held at an operating position out of the neutral position, even though load pressure P_{L} to the second pressure receiving chamber 200 arises, there is no fluctuation in differential pressure before and after passing through the directional control valve 26a, and so the relationship P_{P}=ΔP_{LS}+P_{L} holds and the piston body 112 is maintained at that position, and a fixed oil amount is discharged from the hydraulic pump 74. Conversely, in a transitional state switching from the neutral position to the operating position of the directional control valve 26a, at the instant oil, that until then was held back, begins to flow to the actuator 236, the primary side pressure Pp becomes low, and the differential pressure before and after passing through the directional control valve 26a changes in a direction approaching the load pressure P_{L}. As a result, the relationship P_{P}<ΔP_{LS}+P_{L} comes about. As a result, the balance between the thrust in the rightward direction of the sheet of FIG. 15 and the thrust in the leftward direction, which act on the piston body 112, collapses and the piston body 112 moves to the left of FIG. 15, which is a “direction in which discharge amount becomes large”. In accordance with this movement the spool 102 all the servo mechanism 92 and the servo piston 100 move to the left in FIG. 15. The inclination angle of the variable swash plate 90 then becomes large, and the discharge oil amount of the first hydraulic pump 74 is increased.

After that, the discharge oil amount of the first hydraulic pump 74 is raised, and with the lapse of time fluctuation in differential pressure before and after passing through the previous described variable throttle is resolved, and at the point in time where the relationship P_{P}=ΔP_{LS}+P_{L} is established, thrust on the piston body 112 in the rightward direction the sheets of FIG. 15 is balanced with the first in the leftward direction, and movement of the piston body 112 in the leftward direction is stopped. In this case, the inclination angle of the variable swash plate 90 is maintained at that position by the servo mechanism 92, the discharge oil amount of the first hydraulic pump 74 is kept constant, and the desired actuator working oil amount is obtained. If the switching pilot valves 28a, 28b are put to the neutral position, the unloading valve 118 performs a discharge operation, and the piston body 112 returns to the position of FIG. 15.

In this way, according to this embodiment, it is possible to control the discharge of oil amount of the hydraulic pumps 74, 82 in response to actuator operating load pressure by load sensing, making it possible to curtail surplus flow that is discharged from the hydraulic pumps 74, 82, while discharging a flow amount for hydraulic power required for the load from the hydraulic pumps 74, 82. It is therefore possible to reduce energy consumption. Also, differing from the structure disclosed in JP 3752326B, control of pump discharge capacity is carried out using only pressure variation of the pressure receiving chambers 196, 198, 200 and 200 that constitute the balanced piston mechanisms 94, 98, and there is no disadvantage such as pump control pressure is affected by the amount of expansion or compression of the spring that is provided on the pilot chamber side of a regulator valve corresponding to the load sensing valve. As a result, actuator control can be carried out stably.

Further, it is possible to achieve standardization of a lot of components in a conventional pump unit provided with a servo mechanism, being a swash plate operation section. For example, with this embodiment, a servo mechanism is provided but for a pump unit that does not need a load sensing function it is possible to configure the pump unit 24 of this embodiment using a lot of standadized components. As a result, it is possible to construct the pump unit 24 by fitting a structure possessing a load sensing function to a conventional unit as an option, and in this case there is not a significant change in the components at the hydraulic pump 74, 82 side, making it easy to reduce cost. As a result, according to the pump unit 24, it is possible to stabilize reduction in energy consumption, to more stably control discharge amount of hydraulic pumps 74, 82, with a structure that can standardize a number of components for a pump unit that has servo mechanism but does not require a load sensing function.

In particular, with this embodiment, the second hydraulic pump 82, for driving the second actuator group 248 including the turning motor 16 and the right side traveling motor 34b, is set so that a maximum value for discharge capacity per unit time becomes large compared to that of the first hydraulic pump 74 for driving the first actuator group 246 including the left side traveling motor 34a. Therefore, operation using the upper structure 18, being the turning section, can be carried out smoothly and in a short time. For example, in the case where the second actuator group 248 includes other actuators such as the arm cylinder 58 of the excavator 10, as with this embodiment, even in the event that a turning operation of the upper structure 18 and an operation using the excavation section 40 with the arm cylinder 58 (for example, an operation of rotating the arm 52 up and down with respect to the boom 48) are carried out simultaneously, it is possible to turn the upper structure 18 smoothly and rapidly. Furthermore, a rotation operation of the arm 52 can be carried out smoothly and rapidly. Furthermore, in order to achieve this effect it is not necessary to separately provide a dedicated pump for driving the turning motor 16, making it possible to make the overall pump unit compact, reduce cost, and reduce power loss of the engine 22, which is a power source. As a result, in the excavator 10 it is possible to realize a structure with which it is possible to reduce costs and reduce power loss, and with which an operation using the upper structure 18 can be carried out smoothly and in a short time.

Also, the first hydraulic pump 74 is operationally linked to the second hydraulic pump 82 capable of transmitting power using the step up mechanism 80, and because the step up mechanism 80 includes the large diameter gear 76 and the small diameter gear 78 for stepping up rotational speed of the second hydraulic pump 82 compared to the rotational speed of the first hydraulic pump 74, the second hydraulic pump 82 is set so that a maximum value of discharge capacity per unit time is large compared to that of the first hydraulic pump 74. Since it is therefore possible to standardize a lot of pump body components such as the cylinder block 154 for each of the associated hydraulic pumps 72, 82, further cost reduction is possible. With the example shown in FIG. 15, a relief valve 243 for setting of operating pressure of the switching pilot valves 28a, 28b is provided, but this relief valve 243 can be omitted depending on the situation.

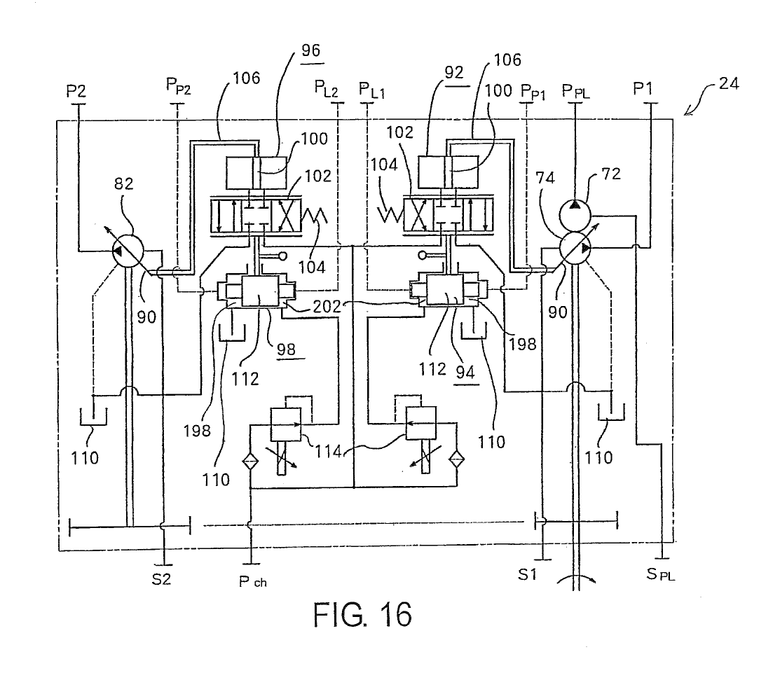

FIG. 16 is a hydraulic circuit diagram for a pump unit 24 of a second embodiment. With the example shown in FIG. 16, differing from the structure that was shown in FIG. 4 etc. described above, a fourth received pressure chamber 198 constituting each balanced piston mechanism 94, 98, communicates with an oil reservoir 110. Also, the third pressure receiving chamber 202 constituting each balanced piston mechanism 94, 98 is connected to the secondary side of a respectively corresponding variable pressure reducing valve 114, which is a variable control pressure reducing valve. At the time of normal operation, the variable pressure reducing valve 114 is controlled so that in a steady state of the directional control valves 26a, 26b (refer to FIG. 3) at the operating position, a set pressure ΔP_{LS} that is set in advance, equivalent to working oil differential pressure arising before and after passing through the directional control valves 26a, 26b, is introduced at the third pressure receiving chamber 202. It is then possible to control the working oil pressure introduced to the third pressure receiving chamber 202 to at or below the set pressure ΔP_{LS}. For example, in a case such as where the engine load becomes a predetermined threshold or greater, or the inclination angle of the variable swash plate 90 becomes a predetermined threshold or greater, a controller, not shown, controls a proportional solenoid of the variable pressure reducing valve 114 so that the working oil pressure introduced to the third pressure receiving chamber 202 become smaller than the set pressure ΔP_{LS}, and the piston body 112 of each balanced piston mechanism 94, 98 is controlled so that discharge capacity of the hydraulic pumps 74, 82 becomes small.

With the pump unit 24 of the second embodiment shown in FIG. 16, while carrying out the same control of pump discharge oil amount as for the pump unit 24 shown in FIG. 4 described above, it is possible to reduce the three pressure reducing valves (fixed pressure reducing valve 116 and variable pressure reducing valves 114 (FIG. 4)) that are used in that structure to two pressure reducing valves. Furthermore, it is possible to effectively prevent deviation from stipulated conditions by adopting a structure in which variable pressure is controlled in accordance with arbitrary stipulated conditions, such as engine load and inclination angle of the variable swash plate 90. Accordingly it is expected to be effective in offering technical advantage to the unit that uses the pump unit 24.

Although not shown in the drawing, a structure in which the second hydraulic pump, which constitutes a drive source for the turning motor 16, is set so that a maximum value for discharge capacity per unit time becomes large compared to that of the first hydraulic pump can also be adopted as the structure for the following a third embodiment or a fourth embodiment. First, with the structure of the third embodiment, the second hydraulic pump is set so that a difference in capacity is provided between respective associated bodies compared to the first hydraulic pump. For example, with the associated first hydraulic pump and second hydraulic pump, a capacity difference is provided by making cross-sectional area of cylinders and corresponding pistons formed in the cylinder block different. In this way, therefore, the second hydraulic pump is set so that a maximum value for discharge capacity per unit time becomes large compared to that of the first hydraulic pump. In the case of this third embodiment also, similarly to the above-described first embodiment, it is possible to make the overall pump unit compact, reduce cost, and reduce power loss, and it is also possible to realize a structure in which an operation using the upper structure 18 that is capable of turning can be carried out smoothly and in a short time.

Also, with the structure of the fourth embodiment, similarly to the above-described first embodiment, the first hydraulic pump 74 is made capable of changing discharge capacity using a structure that includes, as a first pump capacity changing operation mechanism, a corresponding variable swash plate 90, a corresponding operating pin 106, a corresponding first servo mechanism 92 and a first balanced piston mechanism 94. Also, the second hydraulic pump 82 is made capable of changing discharge capacity using a structure that includes a corresponding variable swash plate 90, a corresponding operating pin 106, a corresponding second servo mechanism 96, and the second balanced piston mechanism 98. The first pump capacity changing operating mechanism and the second pump capacity changing operating mechanism are set so that a difference in operating amount range is provided between them. For example, maximum inclination angle of the variable swash plate 90 of the second hydraulic pump 82 may be larger than the maximum inclination angle of the variable swash plate 90 of the first hydraulic pump 74. For example, stoppers for regulating so that the range through which each of the variable swash plates 90, 90 can be inclined is different are provided in the pump case 108. With this structure, the second hydraulic pump 82 is set so that a maximum value for discharge capacity per unit time becomes large compared to that of the first hydraulic pump 74. In the case of this fourth embodiment also, similarly to the above-described first embodiment, it is possible to make the overall pump unit compact, reduce cost and reduce power loss, and it is also possible to realize the structure in which an operation using the upper structure 18 that is capable of turning can be carried out smoothly and in a short time.

As the above description, a hydraulically-powered working vehicle of the present invention comprises a travel unit including a one side travel unit and an other side travel unit that are capable of being driven independently of each other, a turning section provided capable of turning at an upper side of the travel unit, an operation section supported on the turning section, and a hydraulic circuit for the working vehicle, including a plurality of types of actuator, having a one side traveling motor, which is an actuator for driving the one side travel section, an other side traveling motor, which is an actuator for driving the other side travel section, and a turning motor which is an actuator for turning the turning section, wherein the plurality of types of actuator are divided into two groups, being a first actuator group including the one side traveling motor, and a second actuator group including the turning motor and the other side travel monitor, the hydraulic circuit for the working vehicle includes a first circuit having the first actuator group and a first variable capacity pump for driving the first actuator group, and a second circuit having the second actuator group and a second variable pump for driving the second actuator group, and the second variable capacity pump constituting the drive source for the turning motor is set so that a maximum value for discharge capacity per unit time becomes large compared to that of the first variable capacity pump.

According to the above described hydraulically powered working vehicle, a second variable capacity pump for driving a second actuator group, including a turning motor and an other side traveling motor, is set so that a maximum value for discharge capacity per unit time is large compared to that of a first variable capacity pump for driving a first actuator group including a one side traveling motor. Therefore, operation using the turning section can be carried out smoothly and in a short time. For example, in the case where the second actuator group includes another actuator, such as an arm cylinder of an excavator, then even if a turning operation of the turning section and operation using the operating section with another actuator are carried out simultaneously, it is possible to turn the turning section smoothly and rapidly. Furthermore, in order to achieve this effect it is not necessary to separately provide a dedicated pump for driving the turning motor, making it possible to make the overall pump unit compact, reduce cost, and reduce power loss of a power source.

Accordingly, it is possible to realize a structure with which it is possible to reduce cost and reduce power loss, and with which an operation using the turning section can be carried out smoothly and in a short time.

Also, in the hydraulic powered working vehicle of the present invention, preferably, the first variable capacity pump is operationally linked to the second variable capacity pump capable of transmitting power using a pump drive gear, the second variable capacity pump is set so that a maximum value for discharge amount per unit time is large compared to that of the first variable capacity pump by utilizing the fact that the pump drive gear includes a step up gear for stepping up the rotational speed of the second variable capacity pump to be faster than the rotational speed of the first variable capacity pump.

According to the above-described structure, since a lot of pump body components such as a cylinder block can be standardized between the first variable capacity pump and the second variable capacity pump, further cost reduction is possible.

Also, in the hydraulic powered working vehicle of the present invention, preferably, the second variable capacity pump is set so that a maximum value for discharge amount per unit time becomes large compared to that of the first variable capacity pump by providing a capacity difference between the respective associated bodies.

Also, in the hydraulic powered working vehicle of the present invention, preferably, the first variable capacity pump is capable of changing discharge capacity using a first pump capacity changing operation mechanism, while the second variable capacity pump is capable of changing discharge capacity using a second pump capacity changing operation mechanism, and by providing a difference in operating amount range between the first pump capacity changing operating mechanism and the second pump capacity changing operation mechanism, the second variable capacity pump is set so that a maximum value for discharge amount per unit time is large compared to that of the first variable capacity pump.

Also, in the hydraulically powered working vehicle of the present invention, preferably, the plurality of types of actuator include a bucket cylinder, a boom cylinder, a swing cylinder, an arm cylinder, and the blade cylinder, that belong to either the first actuator group or the second actuator group.

What is claimed is:

1. A hydraulically powered working vehicle, comprising:
a travel unit including a one side travel unit and an other side travel unit that are capable of being driven independently of each other;
a turning section provided capable of turning at an upper side of the travel unit;
an operation section supported on the turning section; and
a hydraulic circuit for the working vehicle, including a plurality of types of actuator, having a one side traveling motor, which is an actuator for driving the one side travel section, an other side traveling motor, which is an actuator for driving the other side travel section, and a turning motor which is an actuator for turning the turning section, wherein
the plurality of types of actuator are divided into two groups, being a first actuator group including the one side traveling motor, and a second actuator group including the turning motor and the other side travel monitor,
the hydraulic circuit for the working vehicle includes a first circuit having the first actuator group and a first variable capacity pump for driving the first actuator group, and a second circuit having the second actuator group and a second variable pump for driving the second actuator group, and
the second variable capacity pump constituting the drive source for the turning motor is set so that a maximum value for discharge capacity per unit time becomes large compared to that of the first variable capacity pump.

2. The hydraulically powered working vehicle disclosed in claim 1, wherein
the first variable capacity pump is operationally linked to the second variable capacity pump capable of transmitting power using a pump drive gear,
the second variable capacity pump is set so that a maximum value for discharge amount per unit time is large compared to that of the first variable capacity pump by utilizing the fact that the pump drive gear includes a step up gear for stepping up the rotational speed of the second variable capacity pump to be faster than the rotational speed of the first variable capacity pump.

3. The hydraulically powered working vehicle disclosed in claim 1, wherein
the second variable capacity pump is set so that a maximum value for discharge amount per unit time becomes large compared to that of the first variable capacity pump by providing a capacity difference between the respective associated bodies.

4. The hydraulically powered working vehicle disclosed in claim 1, wherein
the first variable capacity pump is capable of changing the discharge capacity using a first pump capacity change operation mechanism,
the second variable capacity pump is capable of changing the discharge capacity using a second pump capacity change operation mechanism, and
the second variable capacity pump is set so that a maximum value for discharge amount per unit time is large compared to that of the first variable capacity pump by providing a difference in range of operating amount between the first pump capacity change operation mechanism and the second pump capacity change operation mechanism.

5. The hydraulically powered working vehicle disclosed in claim 1, wherein
the plurality of types of actuator include a bucket cylinder, a boom cylinder, a swing cylinder, an arm cylinder, and the blade cylinder, that belong to either the first actuator group or the second actuator group.
